(19) United States
(12) Patent Application Publication
(10) Pub. No.: US 2022/0098019 A1
(43) Pub. Date: Mar. 31, 2022

(54) Combination Coaster and Bottle Opener

(71) Applicant: Nicholas C. Bratta, Addison, IL (US)

(72) Inventor: Nicholas C. Bratta, Addison, IL (US)

(21) Appl. No.: 17/033,556

(22) Filed: Sep. 25, 2020

(51) Int. Cl. B67B 7/44; B67B 7/16; A47G 23/03

(52) U.S. Cl. CPC B67B 7/44; A47G 23/03; B67B 7/16

(57) ABSTRACT

A combination coaster and bottle cap remover having a planer disk with a top surface, a bottom surface, and an outer sidewall between the top surface and the bottom surface. A first semicircle notch is located in the outer sidewall and has a first inner sidewall. The first semicircle notch is located below the top surface and has a first opening passing through the bottom surface, and the first inner sidewall has a diameter similar to a standard bottle cap. A first lip is connected to and extending out from the first inner side wall and adjacent to the bottom surface, and the first lip is sized to fit within the gap created below a bottle cap secured to the top of a standard bottle of beer.

### BACKGROUND OF THE INVENTION

### Field of the Invention

The present invention relates generally to bottle openers, and more particularly, to bottle openers configured within ornamental and decorative configurations.

### Description of Related Art

Openers for alcoholic and soda bottles have been around for many years in many shapes and sizes. While twist-off bottle caps are common, bottle caps requiring a bottle cap remover are still extremely popular. Accordingly, a need for a readily available bottle cap remover is a necessity during social events serving beverages requiring bottle cap removers. However, bottle cap removers are typically unsightly, and therefore, are usually promptly put away after use, resulting in the next person shortly thereafter searching for a bottle cap remover to open his or her beverage bottle.

Accordingly, there is a need for a bottle cap remover that is attractive and readily available during social events involving bottled beverages requiring a bottle cap remover to open.

### ASPECTS AND SUMMARY OF THE PRESENT INVENTION

One aspect of the present invention is to provide a bottle cap opener that is readily available for use to open bottles for people enjoying beverages requiring a bottle cap remover.

Another aspect of the present invention is to provide a bottle cap remover that is neat and attractive in appearance, and thus deters the impulse to put the bottle cap remover away immediately after use.

A further aspect of the present invention is to provide a bottle cap remover that provides a secondary function, thus enabling the bottle cap remover to perform a useful function when not being used as a bottle cap remover.

Another object of the present invention is to provide a bottle cap remover that, due to its secondary useful function, is less likely to be misplaced when a person is seeking a bottle cap remover.

An additional aspect of the present invention is to provide a bottle cap remover that is constructed of durable material to provide years of service.

In order to provide these aspects and others, the present invention provides a combination coaster and bottle opener. Coasters for drinks have long been used to protect delicate table top surfaces from spills, condensation, and hot and cold temperatures associated with beverage bottles and glasses. Using the latest in Computerized Numerical Control (CNC) machining technology, the present invention provides a metallic coaster that is attractive in appearance, practically unbreakable under ordinary conditions of use, inexpensive to produce, and molded to include a bottle cap remover for beer, soda, and various other bottled beverages.

Bottle cap removers or bottle openers are easily lost and frequently difficult to locate when needed. Coasters, on the other hand, are not as likely to get lost, and provide a convenient alternative use when needed. There are coasters in the prior art that include bottle cap remover designs, such as being located in the bottom or passing through the entire thickness of the coaster, but not hidden in the side of the coaster. Unlike current combination coaster and bottle openers, the present invention positions the bottle cap remover in the outer perimeter of the coaster, which is easily located and operates when the coaster is in its upright position, and a user does not need to turn the coaster upside down to operate.

The coaster of the present invention provides a thin profile and solid platform suitable for preventing damage to table surfaces. In addition to supporting a bottle or refreshment drink, and the convenience of having an attached bottle opener function on the side, the coaster of the present invention is designed to include engraved artwork and text in various forms on the top surface for improved marketing and resulting sales. A textured or non-textured neoprene rubber washer is located in a slot on the top surface for softening contact, as well as providing a pleasing contrast against the preferred aluminum constructed embodiment. The coaster includes a raised ridge around the top surface and perimeter that limits transfer of condensation from a cold bottle resting on the coaster to a table surface. The bottom surface of the coaster body includes a bored out, flat bottom hole that reduces weight. The bottom surface of the coaster has a thin cork or rubber material affixed with pressure sensitive adhesive to prevent damage to a table's surface from the bottom of the coaster.

The coaster preferably includes two semicircle notches or pockets each machined in the outer sidewall that are designed to remove a bottle cap. The semicircle notches are machined to the diameter of a standard bottle cap. This helps to position the bottle cap within the center of the semicircle notch and provide for 180 degrees of contact for non-slip performance during removal of a bottle cap.

In accordance with the present invention, the combination coaster and bottle cap remover is constructed as a planer disk with a top surface, a bottom surface, and an outer sidewall between the top surface and the bottom surface. A first semicircle notch is located in the outer sidewall and has a first inner sidewall. The first semicircle notch is located below the top surface and has a first opening passing through the bottom surface, and the first inner sidewall has a diameter similar to a standard bottle cap. A first lip is connected to and extends out perpendicular from the first inner sidewall and adjacent to the bottom surface, and the first lip is sized to fit within a gap created below a bottle cap secured to the top of a standard bottle of beer. The coaster also can include a second semicircle notch in the outer sidewall opposite the first semicircle notch for removing a bottle cap.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed invention and specific embodiments as a basis for designing or modifying other structures for carrying out the same purposes of the present invention, and that such other structures do not depart from the spirit and scope of the invention in its broadest form.

### BRIEF DESCRIPTION OF THE DRAWINGS

FIG. 1 is a perspective view of a coaster configured in accordance with the present invention wherein the coaster is supporting a beverage bottle;

FIG. 2 Is a perspective partial view of the coaster of FIG. 1 receiving a bottle cap within the bottle cap remover of the coaster;

FIG. 3 is a top view of the coaster of FIG. 1 including a non-slip gasket, decorative artwork, and the semicircle notches of the bottle cap removers shown in shadow;

FIG. 4 is an exploded and cross-sectional view of the coaster shown in and taken along line 4-4 of FIG. 3;

FIG. 4a is an enlarged view of the area designated as 4a in FIG. 4;

FIG. 5 is a bottom view of the coaster shown in FIGS. 1-4a;

FIG. 6 is an exploded and cross-sectional view of the coaster shown in and taken along line 6-6 of FIG. 5; and

FIG. 7 is a perspective view of the bottom surface and outer sidewall of the coaster shown in FIGS. 1-6.

### DETAILED DESCRIPTION OF THE PREFERRED EMBODIMENT

Referring now to the drawings, FIG. 1 is a perspective view of a coaster 10 configured in accordance with the preferred embodiment of the present invention. A beverage bottle 12 is illustrated as standing upright with the bottom 14 of the beverage bottle 12 resting on the top surface 16 of the coaster 10. The beverage bottle 12 includes a bottle cap 18 secured to the top 20 of the beverage bottle 12 that is sealing the opening of the beverage bottle 12. The coaster 10 includes a body 11 that can be configured as a planar disk. While the planar disk 11 preferably has a circular configuration, the body 11 can be formed as a square, rectangular, or any other geometric configuration. A raised ridge 22 is formed in the top surface 16 and adjacent to the outer perimeter 24 of the coaster 10. The raised ridge 22 functions to prevent liquids, such as condensation from a cold beverage resting the top surface 16 of the coaster 10, from flowing over the top surface 16 of the coaster 10 and onto a surface of a table or other surface desired to be protected by the coaster 10. An outer sidewall 26 surrounds the perimeter 24 of the coaster 10. A flexible gasket or other non-slip material 28 is secured to the top surface 16 of the coaster 10 prevent the beverage bottle 10 from slipping or making an audible noise when a bottle 12 is located or moved on the top surface 16 of the coaster 10. An opening 43 is shown in the bottom surface 38 within the semicircle notch 30.

In accordance with the present invention, a semicircle notch 30 is located within the outer sidewall 26 of the coaster 10 for a removing bottle cap from a beverage bottle 12 in an easily accessible manner. The coaster 10 can be used to support a beverage bottle 12 when the coaster 10 is not being used as a bottle cap remover.

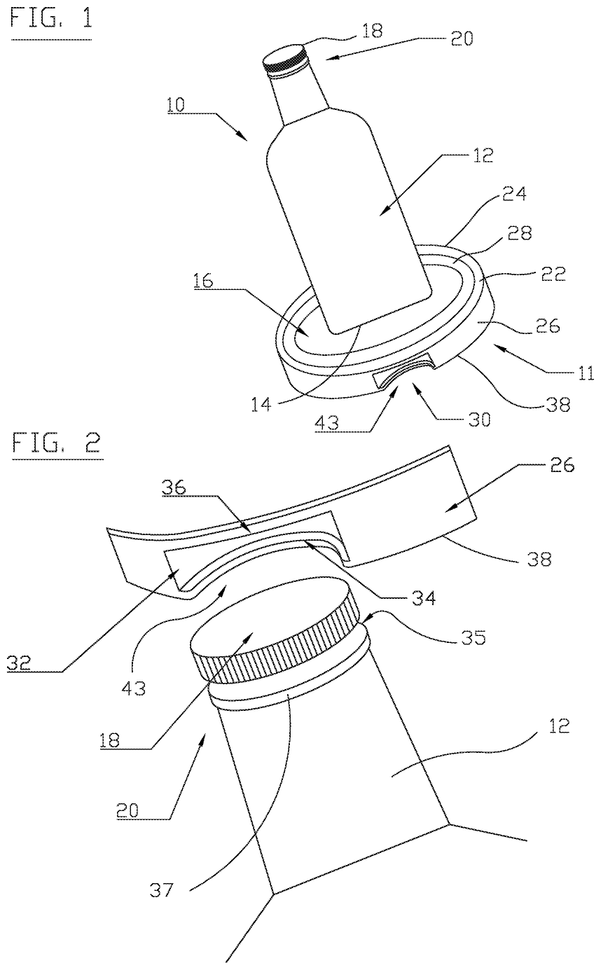

FIG. 2 illustrates an enlarged view of the top 20 of the bottle 12 and a portion of the coaster 10 including the semicircle notch 30 in the outer sidewall 26 of the coaster 10. The semicircle notch, cutout, or radial pocket 30 includes an inner wall 32 having a diameter similar to a standard bottle cap so that a bottle cap preferably fits within the semicircle notch 30 while uniformly contacting the inner sidewall 32 of the semicircle notch 30. The semicircle notch 30 further includes a lip or radial rib 34 extending perpendicular from the inner sidewall 32 and adjacent to the bottom surface 38 of the coaster 10. The lip 34 is sized to fit within the gap 35 located immediately below a bottle cap 18 secured to the top 20 of a bottle 12. If the bottle 12 includes a ridge 37 below the bottle cap 18 secured to the top 20 of the bottle 12, the lip 34 fits in the gap 35 between the bottle cap 18 and the ridge 37. A leverage edge 36 is formed between the upper surface 39 (see FIGS. 5 and 7) of the semicircle notch 30 and the top surface 16 of the coaster 10. The opening 43 also is illustrated in the bottom surface 38 within the semicircle notch 30.

In accordance with a preferred method of the present invention for removing a bottle cap, a bottle cap 18 that is secured to the top 18 of a bottle 12 is inserted into the semicircle notch 30, the lip 34 is located within the gap 35 immediately below the bottle cap 18, and end of the coaster 10 opposite the semicircle notch 30 is rotated upward, thus rotating the coaster 10 around the leverage edge 36 that is in contact with the bottle cap 18, prying up the edge of the bottle cap 18 located within the semicircle notch 30, and removing the bottle cap 18 and opening the beverage bottle 12. In this manner the bottle cap 18 is removed from the bottle 12 while applying minimal upward force.

FIG. 3 is a top view of the coaster 10 shown in FIGS. 1 and 2, wherein the coaster 10 includes engraved artwork or a label 40 for marketing purposes, or simply to improve the aesthetic appearance of the coaster 10. The coaster 10 is preferably a round disk, but can be any geometric shape, such as a square, rectangle, square, or polygon. Also illustrated in shadow in FIG. 3 are a first semicircle notch 30 and a second semicircle notch 42 on the opposing side of the coaster 10, preferably 180 degrees apart. The first semicircle notch 30 and the second semicircle notch 42 are identical, expect for location, and thus, the structure for semicircle notch 42 can be explained by referring to the description of the structure of semicircle notch 30. The opposing first semicircle notch 30 and the second semicircle notch 42 enable both a right-handed and a left-handed person to use the bottle opening function of the coaster 10 with the center piece art work, engraving, or logo 40 facing that person directly when using the bottle opening feature of the coaster 10.

The raised ridge 22 is formed in the top surface 16 and adjacent to the outer periphery of the coaster 10. The raised ridge 22 functions to prevent liquids from flowing off the top surface 16 of the coaster 10 and onto the table or other surface supporting the coaster 10. The coaster 10 is preferably round in shape and the top surface 16 is preferably parallel to the bottom surface 38. The height of the outer sidewall 26 preferably is relatively short compared to the diameter of the round top surface 16 and bottom surface 38 of the coaster 10. The first and second semicircle notches 30 and 42, respectively, and lip 34 are configured for easy opening of a bottle 12 while minimizing the overall height of the coaster 10.

The coaster 10 preferably is machined as a unitary item with extruded aluminum rod, or alternatively, the coaster 10 may be produced from other metals. A black textured or non-textured neoprene rubber washer 44 preferably is secured to the top surface 16 with an adhesive for softening contact with a beverage bottle 12 as well as providing a pleasing contrast against the aluminum embodiment body 11. A center portion 41 of the top surface 16 can provide ornamental CNC precision engraved artwork and/or text 40. The artwork and/or text 40 preferably are color filled with paint for highlighting the design, while providing contrast and aesthetic appeal.

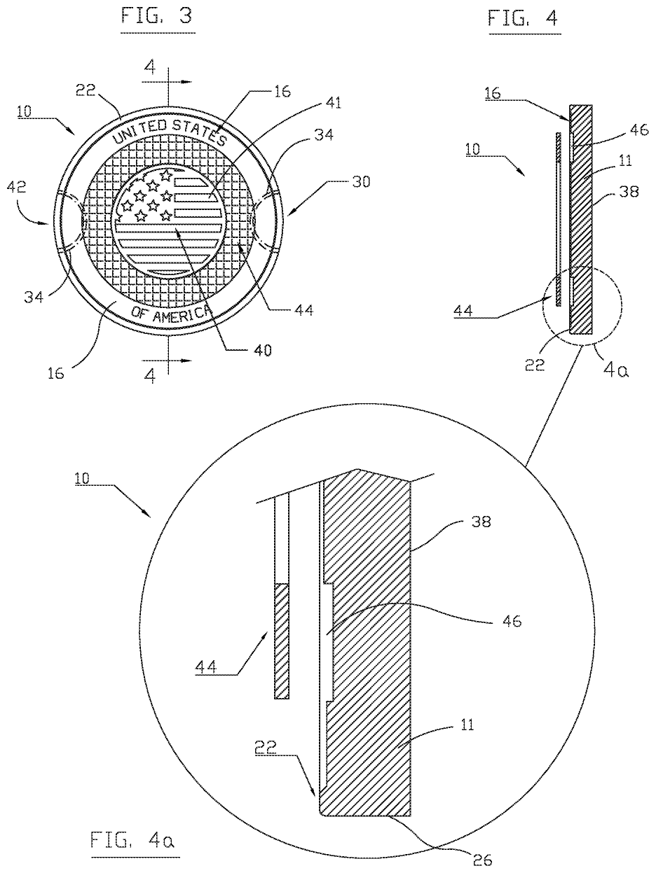

FIG. 4 is a cross-sectional and exploded view of the coaster 10 shown in and taken along line 4-4 in FIG. 3. Illustrated are the body 11 of the coaster 10 and the washer 44. Further illustrated is a slot or indention 46 for placing the washer or gasket 44 within, and preferably, have the top of the washer 44 be slightly above the center 41 of the top surface 16 and flush with the top surface of the raised ridge or drip lip 22.

FIG. 4a is an enlarged view of the exploded portion of FIG. 4 circled and identified as 4a. FIG. 4a illustrates the body 11 of the coaster 10, including the raised ridge 22 and the slot 46 for placing the gasket 44.

FIG. 5 is a bottom view of the coaster 10 shown in FIGS. 1-4a. Illustrated are the semicircle notches 30 and 42, and the lips 34 shown in shadow. The upper surfaces 39 of the semicircle notches 30 and 42 also are illustrated. The openings 43 are illustrated in the bottom surface 38 within the first and second semicircle notches 30 and 42 and directly below the upper surfaces 39. A thin cork or rubber backing material 48 is affixed with pressure sensitive adhesive to the bottom surface 38 of the coaster 10 in order to prevent damage to a table's surface and reduce noise when the coaster 10 is placed or moved upon a table or other surface. The bottom surface 38 of the coaster body 11 includes a bored or milled out aperture, recess, or pocket 50, which reduces the overall weight of the coaster 10. The semicircle notches 30, 42 and ribs 34 are milled out with a woodruff cutter to produce the semicircle notches 30, 42 and ribs 34 that are sized to uniformly engage with the perimeter or edge of a standard bottle cap 18.

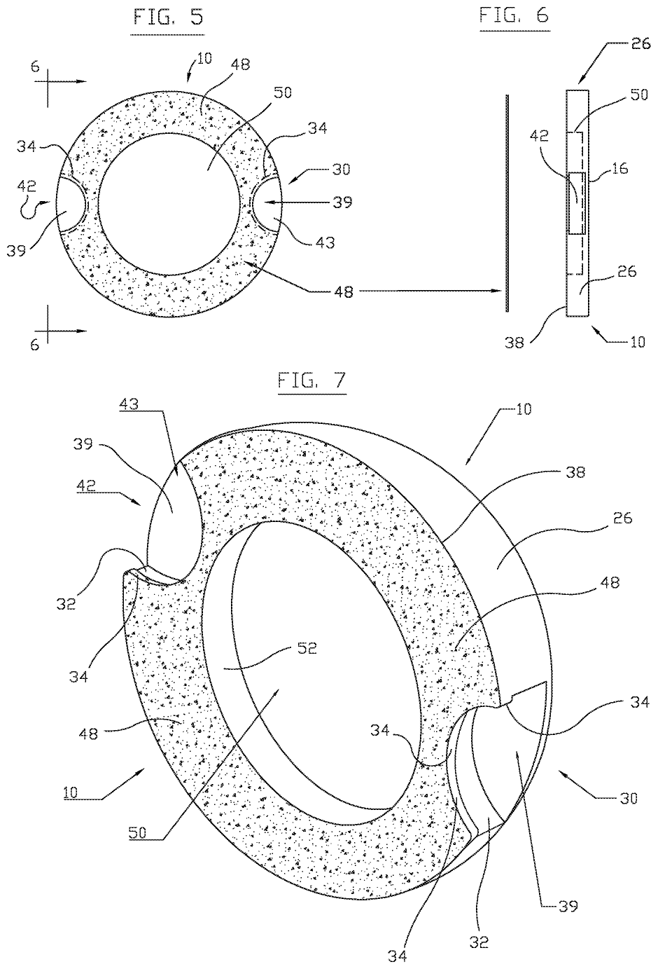

FIG. 6 is a side and exploded view of the coaster 10 shown in and taken along line 6-6 of FIG. 5. Illustrated are the backing material 48, the outer sidewall 26, and the second semicircle notch 42 of the coaster 10. The pocket 50 also is shown in shadow.

FIG. 7 is a perspective view of the coaster 10 shown in FIGS. 1-6. Illustrated are the upper surfaces 39, the inner sidewalls 32, and the ribs 34 of the semicircle notches 30 and 42. The pocket 50 and the inner sidewall 52 of the pocket 50 also are illustrated. The bottom surface 38 and the backing material 48 are shown as well. The openings 43 are illustrated in the bottom surface 38 within the first and second semicircle notches 30 and 42 and directly below the upper surfaces 39.

While specific embodiments have been shown and described to point out fundamental and novel features of the invention as applied to the preferred embodiments, it will be understood that various omissions and substitutions and changes of the form and details of the invention illustrated and in the operation may be done by those skilled in the art, without departing from the spirit of the invention.

1. A combination coaster and bottle cap remover, comprising:
a planer disk having a top surface, a bottom surface, and an outer sidewall between the top surface and the bottom surface;
a first semicircle notch in the outer sidewall having a first inner sidewall, the first semicircle notch located below the top surface and having a first opening passing through the bottom surface, and the first inner sidewall having a diameter similar to a standard bottle cap; and
a first lip connected to and extending out from the first inner sidewall and adjacent to the bottom surface, and the first lip is sized to fit within a space created below a bottle cap secured to a top of a standard beverage bottle.

2. The combination coaster and bottle cap remover of claim 1, further comprising:
a second semicircle notch in the outer sidewall having a second inner sidewall, the second semicircle notch below the top surface and having a second opening passing through the bottom surface, and the second inner sidewall having a diameter similar to a standard bottle cap; and
a second lip connected to and extending out from the second inner sidewall and adjacent to the bottom surface, and the second lip is sized to fit within a space created below a bottle cap secured to a top of a standard beverage bottle.

3. The combination coaster and bottle cap remover of claim 1, further comprising:
a raised ridge on the top surface and adjacent to an outer perimeter of the planar disk, wherein the raised ridge is configured to retain liquid on the top surface of the planar disk.

4. The combination coaster and bottle cap remover of claim 1, wherein the planar disk includes a slot in the top surface for receiving a flexible gasket.

5. The combination coaster and bottle cap remover of claim 4, further comprising:
a flexible gasket located within the slot in the top surface.

6. The combination coaster and bottle cap remover of claim 1, wherein the planar disk includes a pocket in the bottom surface, thereby reducing the weight of the planar disk.

7. The combination coaster and bottle cap remover of claim 1, further comprising:
a beer bottle located on the top surface of the planar disk.

8. The combination coaster and bottle cap remover of claim 1, further comprising:
a backing material located on the bottom surface.

9. The combination coaster and bottle cap remover of claim 1, further comprising:
a bottle cap on a beer bottle located within the first semicircle notch.

10. The combination coaster and bottle cap remover of claim 1, further comprising:
a logo on the top surface of the planar disk.

11. The combination coaster and bottle cap remover of claim 1, wherein the first opening is below a first upper surface of the first semicircle notch.

12. The combination coaster and bottle cap remover of claim 1, wherein the standard beverage bottle is beer bottle.

13. The combination coaster and bottle cap remover of claim 1, wherein the standard beverage bottle is soda bottle.

14. The combination coaster and bottle cap remover of claim 2, wherein the first semicircle notch and the second semicircle notch are located on opposite sides of the outer sidewall of the planar disk.

15. The combination coaster and bottle cap remover of claim 1, wherein the first semicircle notch includes an upper surface above the first opening and below the top surface.
